(19) United States
(12) Patent Application Publication
(10) Pub. No.: US 2015/0077307 A1
(43) Pub. Date: Mar. 19, 2015

(54) ANTENNA STRUCTURE AND WIRELESS COMMUNICATION DEVICE EMPLOYING SAME

(71) Applicant: Chiun Mai Communication Systems, Inc., New Taipei (TW)

(72) Inventors: GENG-HONG LIOU, New Taipei (TW); YEN-HUI LIN, New Taipei (TW)

(21) Appl. No.: 14/481,151

(22) Filed: Sep. 9, 2014

(30) Foreign Application Priority Data
Sep. 18, 2013 (CN) 2013104251042

(51) Int. Cl. H01Q 7/00; H01Q 1/50

(52) U.S. Cl. CPC H01Q 7/00; H01Q 1/50
USPC 343/861; 343/866

(57) ABSTRACT

An antenna structure includes a feeding portion, a grounding portion, a first radiating body, a second radiating body, a first coupling portion and a second coupling portion. The first radiating body is electronically coupled to the grounding portion and the feeding portion. The second radiating body is positioned apart from the first radiation body. The first coupling portion is electronically coupled between the first radiating body and the second radiating body. The second coupling portion faces the first coupling portion and is electronically coupled between the first and second radiating bodies. The first and second radiating bodies, and the first and second coupling portions cooperatively define a loop antenna.

### FIELD

The subject matter herein generally relates to antenna structures, and particular to a multiband antenna structure and wireless communication device employing same.

### BACKGROUND

With improvements in the integration of wireless communication systems, antennas have become increasingly important. For a wireless communication device to utilize various frequency bandwidths, antennas having wider bandwidths have become a significant technology.

### BRIEF DESCRIPTION OF THE DRAWINGS

Implementations of the present technology will now be described, by way of example only, with reference to the attached figures.

FIG. 1 is an isometric view of one embodiment of a wireless communication device employing an antenna structure.

FIG. 2 is similar to FIG. 1, but showing the wireless communication device in another view angle.

FIG. 3 is a circuit diagram showing an impedance matching circuit of the antenna structure as shown in FIG. 1.

FIG. 4 is a diagram showing return loss (“RL”) measurement of the antenna structure when a value of a variable capacitor of the impedance matching circuit is 2.3 pF.

FIG. 5 is a diagram showing total efficiency measurement of the antenna structure when the value of the variable capacitor of the impedance matching circuit is 2.3 pF.

FIG. 6 is a diagram showing RL measurement of the antenna structure when a value of a variable capacitor of the impedance matching circuit is 7 pF.

FIG. 7 is a diagram showing total efficiency measurement of the antenna structure when the value of the variable capacitor of the impedance matching circuit is 7 pF.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

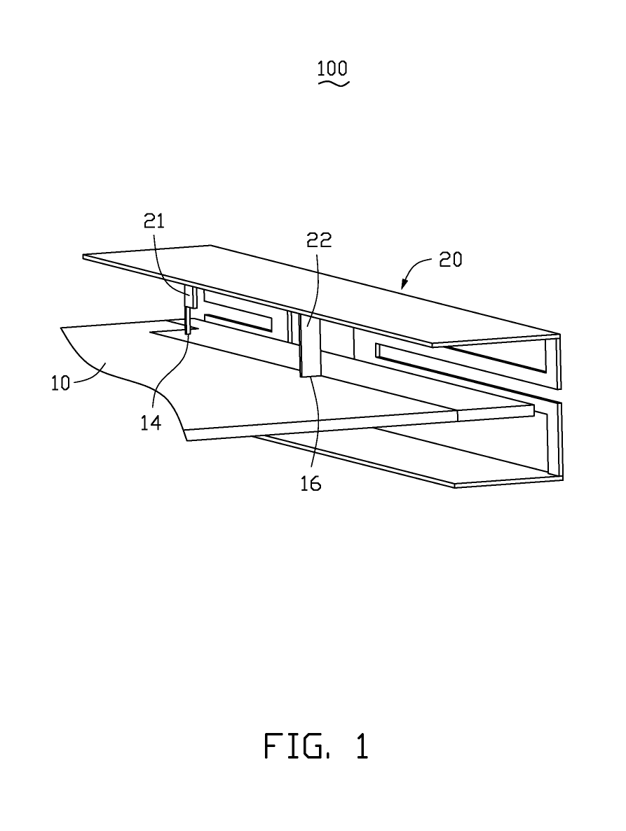

FIG. 1 illustrates an isometric view of one embodiment of a wireless communication device 100 employing a printed circuit board 10 and an antenna structure 20. The printed circuit board 10 includes a feeding point 14 configured to feed current signal and a grounding point 16 electronically coupled to ground.

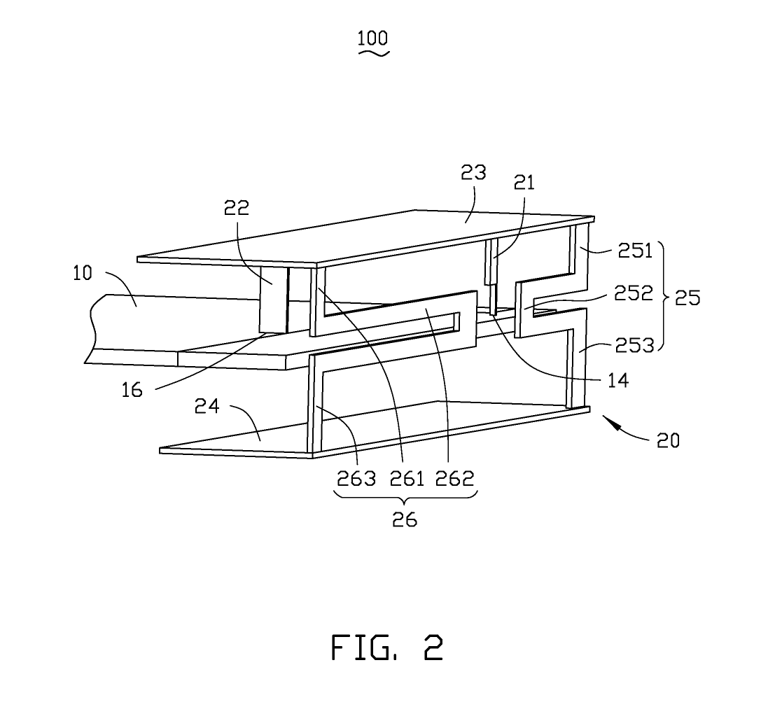

FIG. 2 is similar to FIG. 1, but showing the wireless communication device 100 in another view angle. The antenna structure 20 includes a feeding portion 21 electronically coupled to the feeding point 14 (also see FIG. 1), a grounding portion 22 electronically coupled to the grounding point 16 (also see FIG. 1), a first radiating body 23, a second radiating body 24, a first coupling portion 25, and a second coupling portion 26. The first radiating body 23 is electronically coupled to the grounding portion 22 and the feeding portion 21. The second radiating body 24 is positioned apart from the first radiation body 23. The first coupling portion 25 is electronically coupled between the first and second radiating bodies 23 and 24. The second coupling portion 26 faces the first coupling portion 25, and is electronically coupled between the first and second radiating bodies 23 and 24. The first and second radiating bodies 23 and 24, and the first and second coupling portions 25 and 26 cooperatively define a loop antenna.

The first radiating body 23 and second radiating body 24 are metal sheets, and are parallel to each other. The printed circuit board 10 is parallel to the first and second radiating bodies 23 and 24, and is positioned between and apart from the first and second radiating bodies 23 and 24. In one embodiment, the first radiating body 23 is a portion of a front cover (not shown) of the wireless communication device 100, and is insulative from the remaining portion of the front cover of the wireless communication device 100. The second radiating body 24 is a portion of a back over of the wireless communication device 100, and is insulative from the remaining portion of the back cover of the wireless communication device 100.

The first coupling portion 25 and second coupling portion 26 are meander strips, and are positioned in a plane that is substantially perpendicular to a plane in which the first radiating body 23 is positioned. In particular, the first coupling portion 25 includes a first arm 251, a second arm 252 and a third arm 253 which are coupled sequentially. The first arm 251 is substantially perpendicularly coupled to an edge of the first radiating body 23. The second arm 252 is substantially U-shaped and positioned at a side of the first arm 251 facing the second coupling portion 26. The third arm 253 is substantially perpendicularly coupled to an edge of the second radiating body 24 facing the edge of first radiating body 23.

The second coupling portion 26 includes a first strip 261, a second strip 262, and a third strip 263 which are coupled sequentially. The first strip 261 is substantially perpendicularly coupled to the edge of the first radiating body 23. The second strip 262 is substantially U-shaped and positioned at a side of the first strip 261 facing the first coupling portion 25. The third strip 263 is substantially perpendicularly coupled to the edge of the second radiating body 24. In one embodiment, the second strip 262 aligns with the second arm 252.

The feeding portion 21 and the grounding portion 22 are substantially perpendicularly coupled to a same surface of the first radiating body 23.

In use, the loop antenna generates a low frequency resonate mode and a first high frequency resonant mode that is a harmonic of the low frequency resonate mode; the first and second coupling portions 25 and 26 generates a second high frequency resonate mode and a third high frequency resonate mode respectively.

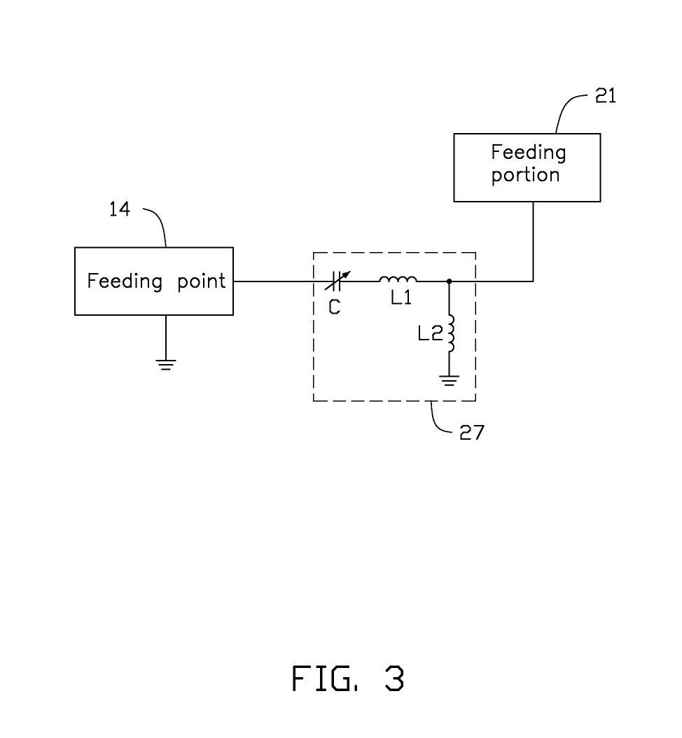

FIG. 3 illustrates a circuit diagram of an impedance matching circuit 27 of the antenna structure 20 as shown in FIG. 2. The impedance matching circuit 27 includes a first inductor L1, a second inductor L2 and a variable capacitor C. The variable capacitor C and the first inductor L1 are electronically coupled in series between the feeding portion 21 and the feeding point 14. The second inductor 12 is electronically coupled to a node between the first inductor 11 and the feeding portion 21, and further electronically coupled to ground.

By changing the capacitance value of the variable capacitor C, the operation frequency at low frequency band of the antenna structure 100 can be adjusted and the antenna characteristic can be improved. In one embodiment, the variable capacitor C can be a digital tuned capacitor that is an integrated circuit capacitor, such as a variable capacitor based on micro-electro-mechanical systems (MEMS) technology. In another embodiment, the variable capacitor C is a capacitance-variable diode of which the capacitance value can be changed by changing an applied voltage. In one embodiment, the capacitance value of the variable capacitor C can be set to either 2.3 pF or 7 pF.

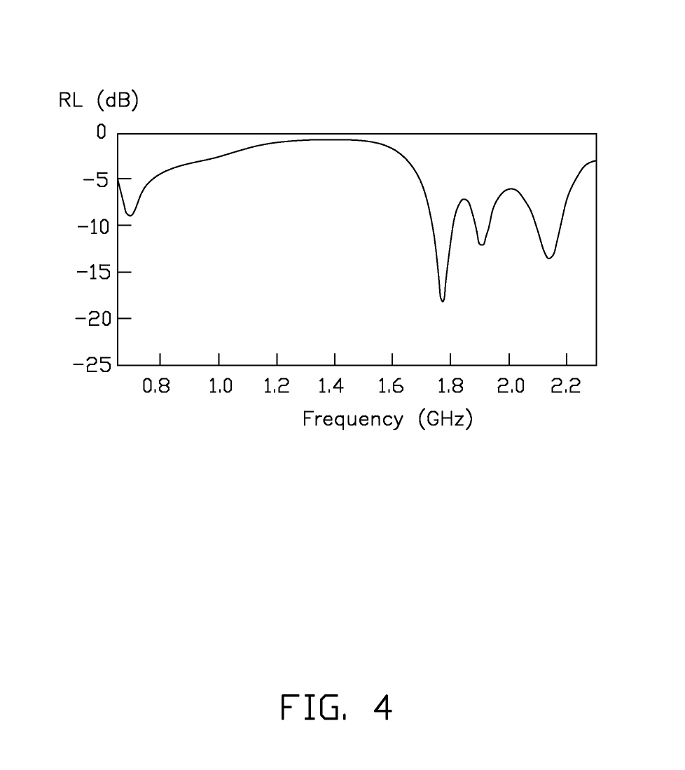

FIG. 4 illustrates a return loss (“RL”) measurement of the antenna structure 20 when the capacitance value of the variable capacitor C is set to 2.3 pF. As shown in FIG. 4, the RL is lower than −5 dB when the antenna structure 20 operates at a low frequency band from about 704 MHz to about 746 MHz and a high frequency band from about 1710 MHz to about 2170 MHz.

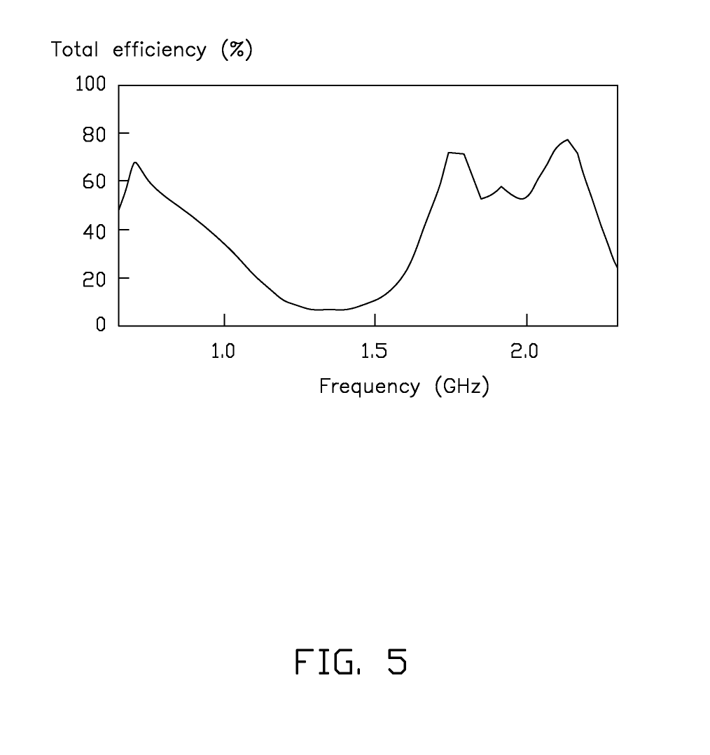

FIG. 5 illustrates a total efficiency measurement of the antenna structure 20 when the capacitance value of the variable capacitor C is set to 2.3 pF. The total efficiency of the antenna structure 20 is in a range from about 60% to about 80% at the low frequency band from about 704 MHz to about 746 MHz, and the total efficiency of the antenna structure 20 is in a range from about 52% to about 76% at the high frequency band from about 1710 MHz to about 2170 MHz.

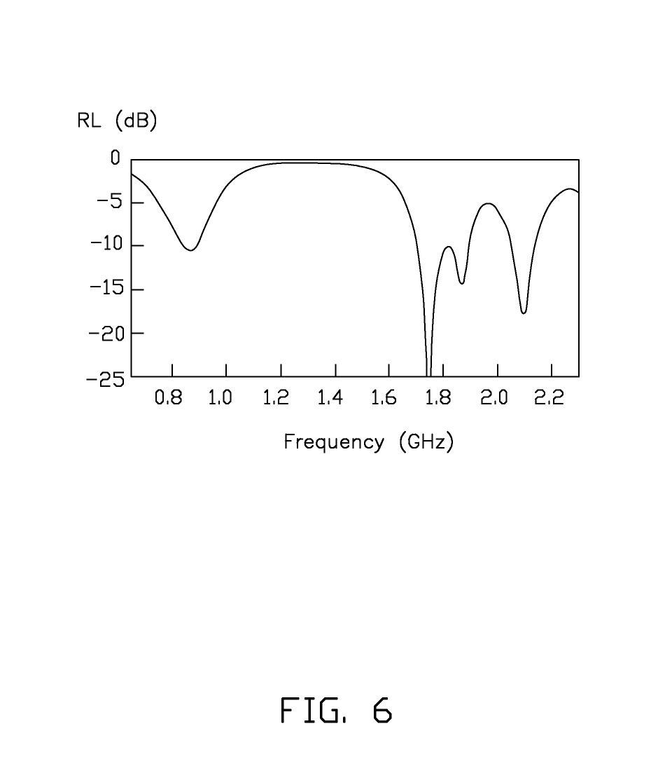

FIG. 6 illustrates a RL measurement of the antenna structure 20 when the capacitance value of the variable capacitor C is set to 7 pF. As shown in FIG. 4, the RL is lower than −5 dB when the antenna structure 20 operates at a low frequency band from about 824 MHz to about 960 MHz and a high frequency band from about 1710 MHz to about 2170 MHz.

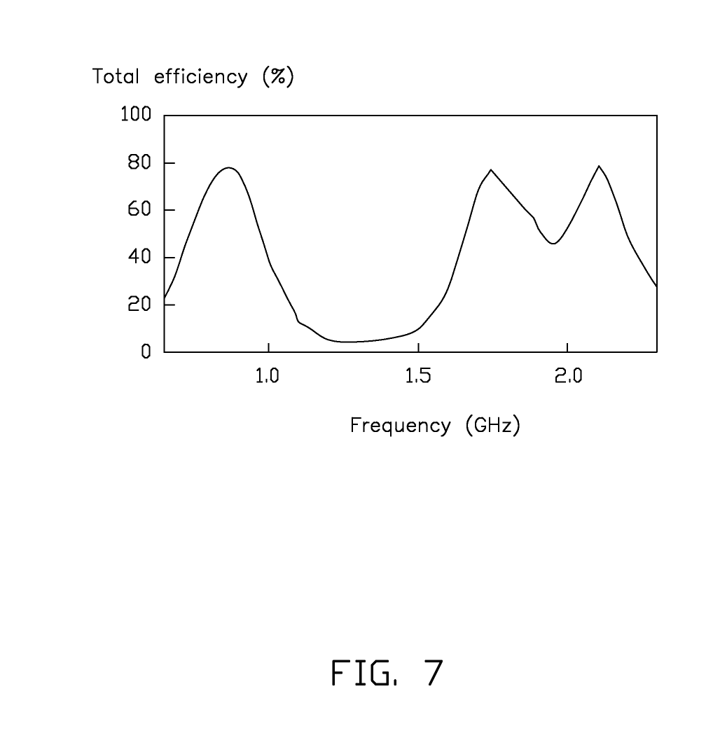

FIG. 7 illustrates a total efficiency measurement of the antenna structure 20 when the capacitance value of the variable capacitor C is set to 7 pF. The total efficiency of the antenna structure 20 is in a range from about 70% to about 79% at the low frequency band from about 824 MHz to about 960 MHz, and the total efficiency of the antenna structure 20 is in a range from about 47% to about 79% at the high frequency band from about 1710 MHz to about 2170 MHz.

Therefore, the antenna structure 20 can operate a low frequency band from about 704 MHz to about 960 MHz, and a high frequency band from about 1710 MHz to about 2170 MHz with an exceptional communication quality.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An antenna structure comprising:
a feeding portion;
a grounding portion;
a first radiating body electronically coupled to the grounding portion and the feeding portion;
a second radiating body positioned apart from the first radiation body;
a first coupling portion electronically coupled between the first and second radiating bodies; and
a second coupling portion facing the first coupling portion and electronically coupled between the first and second radiating bodies; wherein the first and second radiating bodies, and the first and second coupling portions cooperatively define a loop antenna.

2. The antenna structure of claim 1, wherein the first radiating body and second radiating body are metal sheets, and are parallel to each other.

3. The antenna structure of claim 2, wherein the first coupling portion and second coupling portion are meander strips, and are positioned in a plane that is substantially perpendicular to a plane in which the first radiating body is positioned.

4. The antenna structure of claim 3, wherein the first coupling portion comprises a first arm, a second arm and a third arm which are coupled sequentially; the first arm is substantially perpendicularly coupled to an edge of the first radiating body; the second arm is substantially U-shaped and positioned at a side of the first arm facing the second coupling portion; the third arm is substantially perpendicularly coupled to an edge of the second radiating body facing the edge of first radiating body.

5. The antenna structure of claim 4, wherein the second coupling portion comprises a first strip, a second strip, and a third strip which are coupled sequentially; the first strip is substantially perpendicularly coupled to the edge of the first radiating body; the second strip is substantially U-shaped and positioned at a side of the first strip facing the first coupling portion; the third strip is substantially perpendicularly coupled to the edge of the second radiating body.

6. The antenna structure of claim 5, wherein the second strip aligns with the second arm.

7. The antenna structure of claim 2, wherein the grounding portion and the feeding portion are substantially perpendicularly coupled to a same surface of the first radiating body.

8. The antenna structure of claim 1, further comprising an impedance matching circuit having a first inductor, a second inductor and a variable capacitor; wherein the variable capacitor and the first inductor are electronically coupled in series between the feeding portion and a feeding point of a printed circuit board; the second inductor is electronically coupled to a node between the first inductor and the feeding portion, and further electronically coupled to ground.

9. A wireless communication device comprising:
a printed circuit board comprising:
a grounding point;
a feeding point;
an antenna structure comprising:
a feeding portion electronically coupled to the feeding point;
a grounding portion electronically coupled to the grounding point;
a first radiating body electronically coupled to the grounding portion and the feeding portion;
a second radiating body positioned apart from the first radiation body;
a first coupling portion electronically coupled between the first and second radiating bodies; and
a second coupling portion facing the first coupling portion and electronically coupled between the first and second radiating bodies; wherein the first and second radiating bodies, and the first and second coupling portions cooperatively define a loop antenna.

10. The wireless communication device of claim 9, wherein the first radiating body and second radiating body are metal sheets, and are parallel to each other; the printed circuit board is parallel to and positioned between the first and second radiating bodies.

11. The wireless communication device of claim 10, wherein the first coupling portion and second coupling portion are meander strips, and are positioned in a plane that is substantially perpendicular to a plane in which the first radiating body is positioned.

12. The wireless communication device of claim 11, wherein the first coupling portion comprises a first arm, a second arm and a third arm which are coupled sequentially; the first arm is substantially perpendicularly coupled to an edge of the first radiating body; the second arm is substantially U-shaped and positioned at a side of the first arm facing the second coupling portion; the third arm is substantially perpendicularly coupled to an edge of the second radiating body facing the edge of first radiating body.

13. The wireless communication device of claim 12, wherein the second coupling portion comprises a first strip, a second strip, and a third strip which are coupled sequentially; the first strip is substantially perpendicularly coupled to the edge of the first radiating body; the second strip is substantially U-shaped and positioned at a side of the first strip facing the first coupling portion; the third strip is substantially perpendicularly coupled to the edge of the second radiating body.

14. The wireless communication device of claim 13, wherein the second strip aligns with the second arm.

15. The wireless communication device of claim 10, wherein the grounding portion and the feeding portion are substantially perpendicularly coupled to a same surface of the first radiating body.

16. The wireless communication device of claim 9, further comprising an impedance matching circuit having a first inductor, a second inductor and a variable capacitor; wherein the variable capacitor and the first inductor are electronically coupled in series between the feeding portion and the feeding point; the second inductor is electronically coupled to a node between the first inductor and the feeding portion, and further electronically coupled to ground.

17. An antenna structure comprising:
a feeding portion;
a grounding portion;
a first and second radiating body;
a first and second coupling portion;
the first radiating body positioned apart from the second radiating body and coupled to the grounding portion and the feeding portion;
the first coupling portion coupling a first end of the first radiating body with a first end of the second radiating body;
the second coupling portion coupling a second end of the first radiating body with a second end of the second radiating body.

18. The antenna structure of claim 17, wherein the first radiating body and second radiating body are metal sheets, and are parallel to each other; the first coupling portion and second coupling portion are meander strips, and are positioned in a plane that is substantially perpendicular to a plane in which the first radiating body is positioned.

19. The antenna structure of claim 18, wherein the first coupling portion comprises a first arm, a second arm and a third arm which are coupled sequentially; the first arm is substantially perpendicularly coupled to an edge of the first radiating body; the second arm is substantially U-shaped and positioned at a side of the first arm facing the second coupling portion; the third arm is substantially perpendicularly coupled to an edge of the second radiating body facing the edge of first radiating body.

20. The antenna structure of claim 19, wherein the second coupling portion comprises a first strip, a second strip, and a third strip which are coupled sequentially; the first strip is substantially perpendicularly coupled to the edge of the first radiating body; the second strip is substantially U-shaped and positioned at a side of the first strip facing the first coupling portion; the third strip is substantially perpendicularly coupled to the edge of the second radiating body.
